(19) United States
(12) Patent Application Publication
(10) Pub. No.: US 2008/0316744 A1
(43) Pub. Date: Dec. 25, 2008

(54) Surface Light Source Device and Apparatus Using the Device

(75) Inventors: Kazuhide Hirota, Shiga-ken (JP); Masayuki Shinohara, Kyoto-fu (JP)

Correspondence Address: OSHA LIANG L.L.P., TWO HOUSTON CENTER, 909 FANNIN, SUITE 3500, HOUSTON, TX, 77010, US

(73) Assignee: OMRON Corporation, Kyoto-shi, Kyoto (JP)

(21) Appl. No.: 11/629,267

(22) PCT Filed: Jun. 10, 2005
(86) PCT No.: PCT/JP2005/010694

§ 371 Date: Dec. 12, 2006

(30) Foreign Application Priority Data
Jun. 14, 2004 (JP) 2004-175965

(51) Int. Cl. F21V 13/02; F21V 8/00

(52) U.S. Cl. 362/247; 362/236

(57) ABSTRACT

Two light sources 33A and 33B are disposed on a light entrance surface side of a light guiding plate 32. Deflection pattern elements 53A and 53B are disposed concentrically around a middle point Q between the light sources 33A and 33B. One deflection pattern element 53A is disposed in such a fashion that, in plan view, a direction of a normal to a light reflection surface thereof is parallel to a direction connecting the deflection pattern element 53A and the corresponding light source 33A. Also, the other deflection pattern element 53B is disposed in such a fashion that, in plan view, a direction of a normal to a light reflection surface thereof is parallel to a direction connecting the deflection pattern element 53B and the corresponding light source 33B. With such constitution, brightness of a surface light source device is improved.

### TECHNICAL FIELD

This invention relates to a surface light source device and apparatuses using the device. More specifically, this invention relates to a surface light source device as well as to a liquid crystal display apparatus, a mobile phone, and an information terminal using the surface light source device.

### RELATED ART

FIG. 1 is a schematic diagram showing a structure of a liquid crystal display apparatus 11. The liquid crystal display apparatus 11 is formed of a liquid crystal display panel 12, a diffusion sheet 13, and a surface light source device 14. The liquid crystal display panel 12 has a function of generating an image by transmitting or interrupting light for each of pixels but does not have a function of emitting light by itself. Therefore, the surface light source device 14 which is to be provided on a front surface or a rear surface of the liquid crystal display panel 12 is required for illuminating the liquid crystal display panel 12. The surface light source device 14 can be broadly divided into a front light type which is disposed on the front surface of the liquid crystal display panel 12 and a backlight type which is disposed on the rear surface of the liquid crystal display panel 12. The backlight type will herein after be described.

FIG. 2 is an exploded perspective view showing the backlight type surface light source device 14, and FIG. 3 is a schematic sectional view showing the backlight type surface light source device 14. The surface light source device 14 is formed of a light guiding plate 15 for entrapping light, a light emission unit 16, and a reflection plate 17. The light guiding plate 15 is molded from a resin which is transparent and has a large refractive index, such as a polycarbonate resin and a methacryl resin, and diffusion pattern elements 18 are formed on a lower surface of the light guiding plate 15 by pattering processing, dot printing of diffuse reflection ink, or the like. The light emission unit 16 has a circuit substrate 19 and a so-called point light source 20 mounted on the circuit substrate 19, such as a plurality of light emitting diodes (LED), the light emission unit 16 being opposed to a side surface (light entrance surface 21) of the light guiding plate 15. The reflection plate 17 is formed from a white resin sheet, for example, which is high in reflectance, and both sides of the reflection plate 17 are attached to the lower surface of the light guiding plate 15 by a two-sided adhesive tape 22.

However, as shown in FIG. 3, with this surface light source device 14, light f emitted from the light emission unit 16 enters the light guiding plate 15 from the light entrance surface 21. The light f introduced into the light guiding plate 15 is diffusedly reflected by the diffusion pattern element 18 when passing through the light guiding plate 15, and the light f is made incident to the light exit surface 23 at an incident angle smaller than a critical angle of total reflection to exit to the outside from the light exit surface 23. The light f leaked from the lower surface of the light guiding plate 15 after passing through a part of the lower surface of the light guiding plate 15 wherein the diffusion pattern element 18 does not exist is reflected by the reflection plate 17 to return to the inside of the light guiding plate 15, so that a light amount loss on the lower surface of the light guiding plate 15 is prevented.

However, since the light emission unit 16 in the above surface light source device 14 is a linear light source using the multiple of the point light sources 20, power consumption of the light emission unit 16 is large. Also, since the light is diffused by the diffusion pattern element 18 of the light guiding plate 15 and then exits from the light exit surface 23, a directivity characteristic of the light exiting from the light exit surface 23 is increased to undesirably reduce front surface brightness.

Due to the compactness and lightness, the surface light source device using the point light source such as the LED is used for commercial products that has high mobility, such as a mobile phone and a QDA because of its small size and weight. There is a strong demand that these commercial products are increased in power source life from the stand point of improvement in mobility, and there is a strong demand that the surface light source which is used for the commercial products is reduced in power consumption. Therefore, a more efficient light source is in demand, and, as a result, there is a tendency of reducing the number of light sources. The lower power consumption has been achieved by surface light source devices using one or a several light sources.

Under the circumstances, Japanese Patent No. 3151830 (Patent Publication 1) discloses a surface light source device capable of emitting light having a narrow directivity characteristic by using one or a several light sources. FIG. 4 is a schematic plan view illustrating the surface light source device using one light source, wherein a light source 24 and deflection pattern elements 26 recessed on a light emission region of a lower surface of a light guiding plate 25 are shown. In the surface light source device, the light source 24 is disposed at a central part of one of sides of the light guiding plate 25.

The deflection pattern elements 26 each having a triangle prism shape and being elongated in one direction are disposed on the lower surface of the light guiding plate 25 concentrically around the light source 24. Each of the deflection pattern elements 26 is disposed in such a fashion that a direction connecting the deflection pattern element 26 and the light source 24 is perpendicular to a length direction of the deflection pattern element 26. To be more precise, when viewed from a direction perpendicular to the light guiding plate 25, each of the deflection pattern elements 26 is disposed in such a fashion that a normal to a light reflection surface of the deflection pattern element 26 is parallel to the direction connecting the deflection pattern element 26 and the light source 24. Therefore, light transmitting inside the light guiding plate 25 is not diffused to a circumferential direction from the light source 24 after being reflected by the deflection pattern elements 26, but proceeds straight in a radial pattern from the center which is the light source 24 as viewed from the direction perpendicular to the light guiding plate 25. Therefore, the light transmitting inside the light guiding plate 25 has the narrow directivity in the circumferential direction from the light source 24 serving as the center.

The light emitted from the light source 24 transmits in a radial pattern inside the light guiding plate 25 by repeating total reflection between the upper surface and the lower surface of the light guiding plate 25 to be reflected by the deflection pattern elements 26. The light is then oriented to a direction substantially perpendicular to a light exit surface to exit outside from the light exit surface.

As a result, in the above-described surface light source device, the light exiting from the light exit surface of the light guiding plate 25 has the narrow directivity characteristic in the two directions. As shown in FIG. 5, a z-axis direction is set to the direction of the normal to the light exit surface of the light guiding plate 25; an r-axis is set to a moving radius direction around the light source 24; a θ-axis direction is set to a tangent direction of the circumference around the light source 24; an azimuth measured from the z-axis on a plane including the z-axis and the r-axis is represented by ξ; and an azimuth measured from the z-axis on a plane including the z-axis and the θ-axis is represented by η in this specification (the symbols are used also for describing this invention). In this case, the light exiting from the light exit surface of the light guiding plate 25 has the narrow directivity characteristic in the ξ-direction and the η-direction of FIG. 5.

Therefore, with the above-described surface light source device, it is possible to reduce the number of light sources and the power consumption as well as to improve the front surface brightness by enhancing light use efficiency by collecting the light to the front surface of the surface light source device as much as possible. That is, it is possible to realize a surface light source device which is bright and reduced in power consumption.

In a surface light source device shown in FIG. 6, the light guiding plate 25 used in the surface light source device of FIG. 4 is used, and two light sources 24 are disposed on a light entrance surface side of the light guiding plate 25. It is desirable to use plural light sources in some cases such as the case of increasing brightness of the light exit surface of the surface light source device and the case of combining light sources different in light emission color. In such cases, the plural light sources 24 are disposed on the light entrance side of the light guiding plate 25 in such a fashion that a middle point of the two light sources 24 overlaps with the center of the deflection pattern elements 26 disposed in the concentric fashion.

However, in the combination of the plural light sources and the deflection pattern elements 26 disposed concentrically around one point as shown in FIG. 6, brightness of the surface light source device is reduced in the vicinity of the light sources 24 to generate a dark part 27 as shown in FIG. 7. An increase in pattern density of the light deflection pattern elements 26 in the vicinity of the light sources 24 to the maximum does not eliminate the dark part 27, and it is difficult to maintain uniformity of brightness in a light emission region of the surface light source device.

Accordingly, as a result of pursuit for the cause of the dark part by the inventors of this invention, it was detected that the dark part is attributable to a very small positional difference between the positions of the light sources and the center of the deflection pattern elements 26 disposed concentrically. Hereinafter, the cause will be described in detail. In the case of mounting a plurality of very small light sources which is in the form of a block on a flexible printed circuit board, a gap K of a several millimeters occurs between the centers (light emission points) of the light sources 24 as shown in FIG. 8 regardless of localization of the light sources 24 by bringing them closer to each other since each of the light sources 24 has the size of a several millimeters. In turn, the deflection pattern elements 26 are disposed concentrically around the middle point Q between the light sources 24, and a length direction of each of the deflection pattern elements 26 is perpendicular to a line segment connecting the middle point Q and the deflection pattern element 26.

As shown in FIG. 7, in a region distant from the light sources 24 on the light guiding plate 25, the gap K between the light sources 24 is remarkably small as compared to a distance between the position P1 of the light deflection pattern element 26 distant from the light sources 24 and the light sources 24. Accordingly, an incident angle α of light made incident to the deflection pattern element 26 at the position P1 is small. Therefore, the positional difference between the positions of the light sources 24 and the middle point Q of the deflection pattern elements 26 disposed concentrically is not problematic, and the surface light source device emits light at uniform brightness in the region distant from the light source 24.

In contrast, in the vicinity of the light sources 24, behavior of light f is as shown in FIGS. 8 and 9. FIG. 8 is a schematic enlarged plan view showing the vicinity of the light sources. FIG. 9 is a sectional view taken along the line X-X of FIG. 8, wherein a plane perpendicular to the r-axis (a plane parallel to the zθ plane) in the vicinity of the light sources is shown. As shown in FIG. 8, the lights f1 and f2 emitted from the light sources 24 are made incident to a normal to the deflection pattern element 26 at a large incident angle α from an oblique direction when viewed from a direction perpendicular to the light exit surface of the light guiding plate 25. Accordingly, the lights f1 and f2 reflected by the deflection pattern element 26 are oriented to oblique directions inclined from the z-axis as shown in FIG. 9 when exiting from the light exit surface 28 to a plane substantially parallel to the zθ plane. As a result, directivity characteristics of the lights f1 and f2 exiting from the light exit surface 28 in the plane parallel to the zθ plane are as shown in FIG. 10. FIG. 10 is a diagram showing the directivity characteristics of the lights exiting from the light exit surface to the zθ plane, wherein the horizontal axis represents the azimuth η (see FIG. 5), and the vertical axis represents light intensity. Since intensity of the light exiting from the light exit surface 28 reaches to the maximum in the direction inclined from the z-axis direction in the zθ plane as shown in FIG. 9, the directivity characteristics of the lights f1 and f2 of the light sources 24 exiting from the light exit surface 28 are as indicated by the broken line in FIG. 10. The directivity characteristic of the light emitted from the surface light source device is obtained by adding up the characteristics represented by the broken line and is represented by the thick line in FIG. 10. According to the directivity characteristic of FIG. 10, the light intensity reaches to the maximum in the direction inclined from the front surface of the surface light source device and is reduced prominently in the frontward direction (z-axis direction) in the case of using the plural light sources 24.

In the case of using the plural light sources as describe above, the amount of outgoing light in the frontward direction is reduced in the vicinity of the light sources. Particularly, in the vicinity of the light sources, the incident angle α is 45° or more, and the amount of outgoing light in the frontward direction is substantially 0. Therefore, in the case of using the plural light sources, the brightness of the light exit surface is reduced in the vicinity of the light sources to generate the dark part in the vicinity of the light sources.

Patent Publication 1: Japanese Patent No. 3151830

Patent Publication 2: JP-A-2003-215584

Patent Publication 3: WO00-49432

### DISCLOSURE OF THE INVENTION

### Problems to be Solved by the Invention

This invention was accomplished in view of the above-described technical problems, and an object thereof is to provide a surface light source capable of suppressing, when using a plurality of light sources, a phenomenon of occurrence of a part reduced in brightness in the vicinity of the light sources.

### Means for Solving the Problems

A first surface light source device according to this invention comprises a light guiding plate for drawing light introduced from a light entrance surface from a light exit surface to outside by entrapping and transmitting the light and a plurality of light sources disposed on a light entrance surface side of the light guiding plate, the surface light source device being characterized in that a deflection pattern region comprising a plurality of deflection pattern elements disposed with a gap being defined between the adjacent deflection pattern elements is formed on a surface opposite to the light exit surface of the light guiding plate, and the deflection pattern elements are disposed in such a fashion that: one of the deflection pattern elements corresponds to one of the light sources; another one of the deflection pattern elements corresponds to the other light source; and a normal to a light reflection surface of each of the deflection pattern elements is parallel to a direction connecting the deflection pattern element and the corresponding light source when viewed from a direction perpendicular to the light exit surface. As used herein, “a normal to a light reflection surface of each of the deflection pattern elements is parallel to a direction connecting the deflection pattern element and the corresponding light source” means that it is sufficient that the normal and the direction are substantially parallel to each other, not necessarily precisely parallel to each other.

In the first surface light source device according to this invention, since the deflection pattern elements are disposed in such a fashion that: one of the deflection pattern elements corresponds to one of the light sources; another one of the deflection pattern elements corresponds to the other light source; and the normal to the light reflection surface of each of the deflection pattern elements is parallel to the direction connecting the deflection pattern element and the corresponding light source when viewed from the direction perpendicular to the light exit surface, light emitted from each of the light sources proceeds straight when viewed from the direction perpendicular to the light exit surface after being reflected by the corresponding deflection pattern element and then exits outside from the light exit surface of the light guiding plate. Therefore, it is possible to draw the light from the light source frontward in the vicinity of the light sources and to prevent a reduction in amount of outgoing light in the vicinity of the light sources, thereby achieving uniform brightness in an overall light emission region of the surface light source device.

One embodiment of the first surface light source device of this invention is characterized in that the deflection pattern elements corresponding to the light sources are distributed at a constant rate in an arbitrary part of the deflection pattern region which is sufficiently larger than the deflection pattern elements and sufficiently smaller than the light guiding plate. According to this embodiment, it is possible to further improve the brightness uniformity in an arbitrary part of the light emission region of the surface light source device.

An other embodiment of the first surface light source device of this invention is characterized in that the deflection pattern elements are increased in total area of light reflection surfaces per unit area of the light exit surface with an increase in distance between each of the deflection pattern elements and the corresponding light source. According to this embodiment, since the total area of the light reflection surfaces per unit area of the light exit surface is increased in a region where it is difficult for the light from the light source to reach due to the distance from the light source, it is possible to achieve uniform brightness in an overall light emission region of the surface light source device. A number density of the deflection pattern elements may be increased or an area of the light reflection surface may be increased by increasing a length of each of the deflection pattern elements as s a method of increasing the total area of the light reflection surfaces per unit area of light exit surface.

Still another embodiment of the first surface light source device of this invention is characterized in that the deflection pattern elements are disposed in such a fashion that: one of the deflection pattern elements corresponds to one of the light sources; another one of the deflection pattern elements corresponds to the other light source; and a normal to a light reflection surface of each of the deflection pattern elements is parallel to a direction connecting the deflection pattern element and the corresponding light source when viewed from a direction perpendicular to the light exit surface in the vicinity of the light sources and that the normal to the light reflection surface of each of the deflection pattern elements is parallel to a direction connecting the deflection pattern element and a central part of the light sources when viewed from the direction perpendicular to the light exit surface in a region distant from a part on which the light sources are disposed. Brightness in the vicinity of the light sources is increased in the case where the normal to the light reflection surface of each of the deflection pattern elements is parallel to the direction connecting the deflection pattern element and the corresponding light source when viewed from the direction perpendicular to the light exit surface, and brightness in the region distant from the light sources is increased in the case where the deflection pattern elements are disposed concentrically around the center of the light sources. Therefore, it is possible to improve brightness in the whole surface light source device.

A second surface light source device according to this invention comprises: a light guiding plate for drawing light introduced from a light entrance surface from a light exit surface to outside by entrapping and transmitting the light; a plurality of light sources disposed on a light entrance surface side of the light guiding plate; and a prism sheet opposed to the light exit surface of the light guiding plate, the second surface light source device being characterized in that: a deflection pattern region comprising a plurality of deflection pattern elements disposed with a gap being defined between the adjacent deflection pattern elements is formed on a surface opposite to the light exit surface of the light guiding plate; a plurality of prisms are aligned on a surface of the prism sheet opposed to the light guiding plate; and light emitted from each of the light sources transmits through the light guiding plate to be reflected by the deflection pattern element corresponding to the light source to a direction orthogonal to a length direction of the prisms when viewed from a direction perpendicular to the light exit surface and then exits outside from the light exit surface, so that the light exited from the light exit surface is reflected by the prisms after entering the prisms to be deflected to a direction perpendicular to the prism sheet.

In the second surface light source device of this invention, the light emitted from each of the light sources transmits through the light guiding plate to be reflected by the deflection pattern element corresponding to the light source to the direction orthogonal to the length direction of the prisms when viewed from the direction perpendicular to the light exit surface and then exits outside from the light exit surface, so that the light exited from the light exit surface is reflected by the prisms after entering the prisms to be deflected to the direction perpendicular to the prism sheet. Therefore, the light of the light source is emitted to the frontward direction in the vicinity of the light source, so that it is possible to prevent a reduction in an amount of outgoing light in the vicinity of the light sources and to achieve improvement in brightness of the surface light source device with the use of a reduced number of light sources.

One embodiment of the second surface light source device of this invention is characterized in that the deflection pattern elements corresponding to the light sources are distributed at a constant rate in an arbitrary part of the deflection pattern region which is sufficiently larger than the deflection pattern elements and sufficiently smaller than the light guiding plate. According to this embodiment, it is possible to further improve the brightness uniformity in an arbitrary part of the light emission region of the surface light source device.

An other embodiment of the second surface light source device of this invention is characterized in that the deflection pattern elements are increased in total area of light reflection surfaces per unit area of the light exit surface with an increase in distance between each of the deflection pattern elements and the corresponding light source. According to this embodiment, since the total area of the light reflection surfaces per unit area of the light exit surface is increased in a region where it is difficult for the light from the light source to reach due to the distance from the light source, it is possible to achieve uniform brightness in an overall light emission region of the surface light source device. A number density of the deflection pattern elements may be increased or an area of the light reflection surface may be increased by increasing a length of each of the deflection pattern elements as s a method of increasing the total area of the light reflection surfaces per unit area of light exit surface.

A liquid crystal display apparatus according to this invention is characterized by comprising a liquid crystal display panel for generating an image and the first or the second surface light source device according to this invention for illuminating the liquid crystal display panel. According to the liquid crystal display apparatus according to this invention, since it is possible to suppress a reduction in brightness in the vicinity of the light sources of the surface light source device, it is possible to display the image having uniform brightness, thereby improving visibility.

Also, this liquid crystal display apparatus is usable for a mobile phone having a communication function, an information terminal having an information processing function, and the like.

It is possible to combine the components of this invention described above as arbitrarily as possible.

### BRIEF DESCRIPTION OF DRAWINGS

FIG. 1 is a schematic diagram showing a structure of a liquid crystal display apparatus.

FIG. 2 is an exploded perspective view showing a conventional surface light source device.

FIG. 3 is a schematic sectional view showing the surface light source device of FIG. 2.

FIG. 4 is a schematic plan view illustrating a conventional surface light source using one light source.

FIG. 5 is a diagram showing definition of directions and azimuth angles used in this specification.

FIG. 6 is a diagram illustrating a surface light source device having two light sources disposed on a light guiding plate used in the surface light source device of FIG. 4.

FIG. 7 is a diagram showing a dark part generated in the vicinity of the light sources in the surface light source device shown in FIG. 6.

FIG. 8 is a diagram showing directions of lights entering one deflection pattern element in the surface light source device of FIG. 6.

FIG. 9 is a diagram showing directions of lights reflected by one deflection pattern element in the surface light source device of FIG. 6.

FIG. 10 is a diagram showing directivity characteristics of lights exiting from light exit surface in the surface light source device of FIG. 6.

FIG. 11 is an exploded perspective view showing a surface light source device according to Embodiment 1 of this invention.

FIG. 12 is an exploded perspective view showing a structure for fixing light sources to a light guiding plate with a bracket.

FIG. 13 is a diagram illustrating layout of deflection pattern elements provided in a deflection pattern region on a backside of the light guiding plate.

FIG. 14 is a diagram showing a section of the deflection pattern element.

FIG. 15(a) and FIG. 15(b) are diagrams showing a function of the deflection pattern element.

FIG. 16 is a plan view showing a modification example of the deflection pattern element.

FIG. 17 is a schematic sectional view illustrating behavior of lights in the surface light source device of Embodiment 1.

FIG. 18 is a diagram showing directions of lights entering the deflection pattern elements.

FIG. 19 is a diagram showing directions of lights exiting from a light exit surface after being reflected by the deflection pattern elements.

FIG. 20(a) is a diagram showing a directivity characteristic of light reflected by one of the deflection pattern elements; FIG. 20(b) is a diagram showing a directivity characteristic of light reflected by the other deflection pattern element; and FIG. 20(c) is a diagram showing the directivity characteristics of both of the deflection pattern elements as overlapped with each other.

FIG. 21 is a diagram illustrating a modification example of Embodiment 1.

FIG. 22 is a diagram illustrating another modification example of Embodiment 1.

FIG. 23 is a diagram illustrating a surface light source device according to Embodiment 2 of this invention.

FIG. 24 is a diagram showing a relationship between efficiency of a surface light source device and a distance from a light source by using the surface light source devices of the conventional example, Embodiment 1, and Embodiment 2.

FIG. 25 is a diagram illustrating a structure of Embodiment 3 of this invention.

FIG. 26 is an exploded perspective view showing a surface light source device according to Embodiment 4 of this invention.

FIG. 27 is a perspective view as viewed from a backside of a prism sheet used in Embodiment 4.

FIG. 28 is a schematic sectional view illustrating behavior of lights in the surface light source of Embodiment 4.

FIG. 29 is a schematic diagram illustrating layout of deflection pattern elements in Embodiment 4.

FIG. 30 is a schematic diagram illustrating layout of deflection pattern elements in Embodiment 4.

FIG. 31 is a schematic diagram showing a liquid crystal display apparatus according to this invention.

FIG. 32(a) is a schematic perspective view showing a mobile phone according to this invention, and FIG. 32(b) is a schematic perspective view showing an information terminal according to this invention.

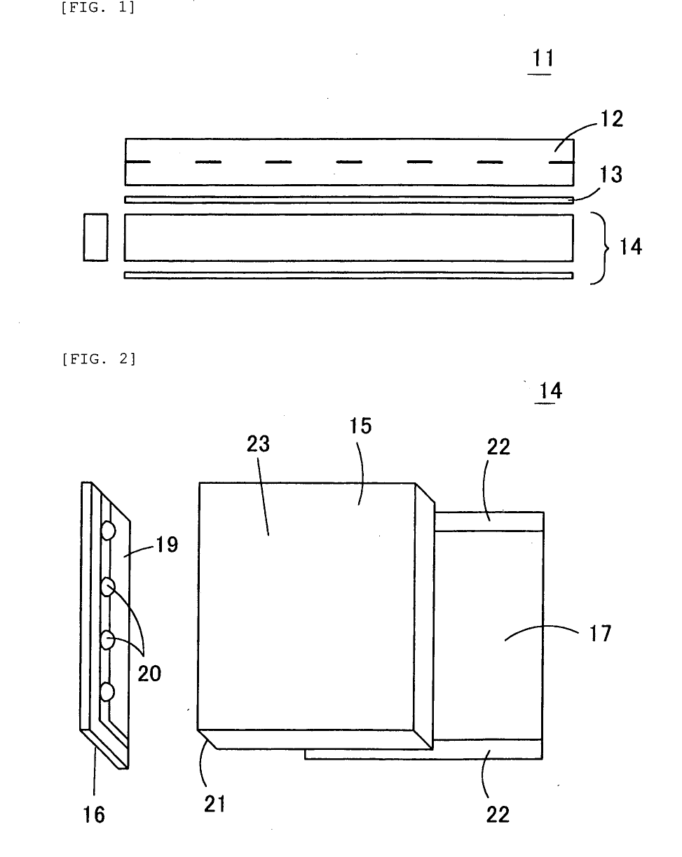

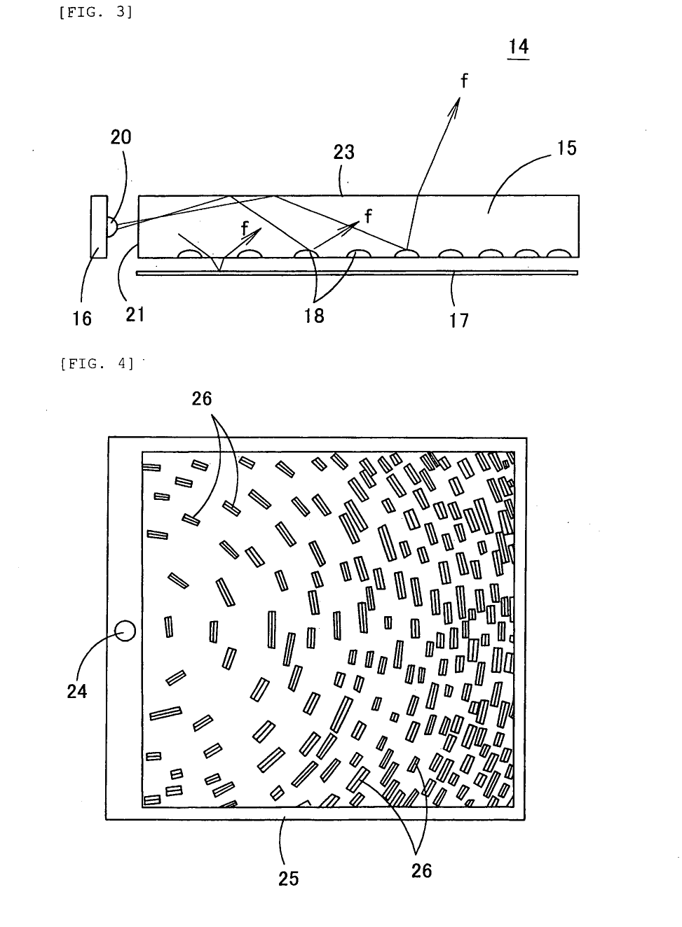

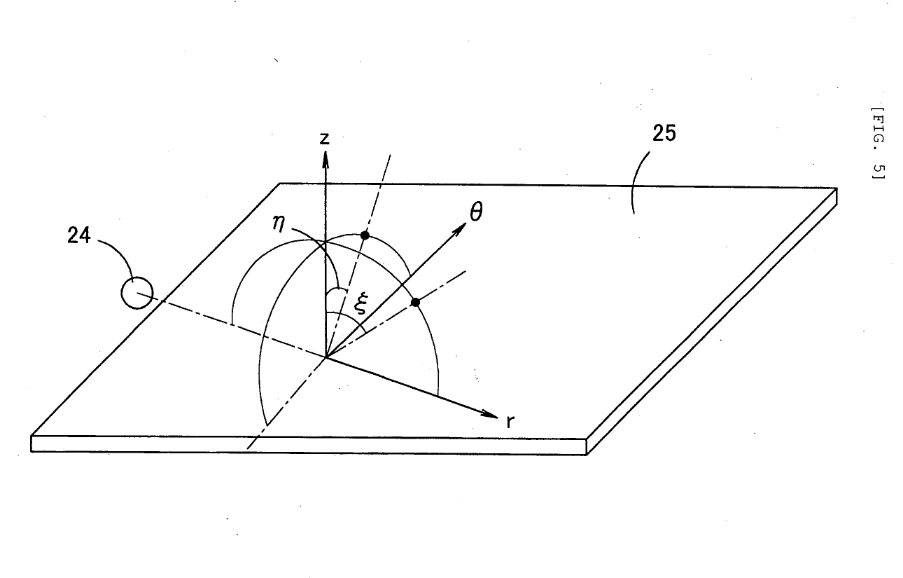

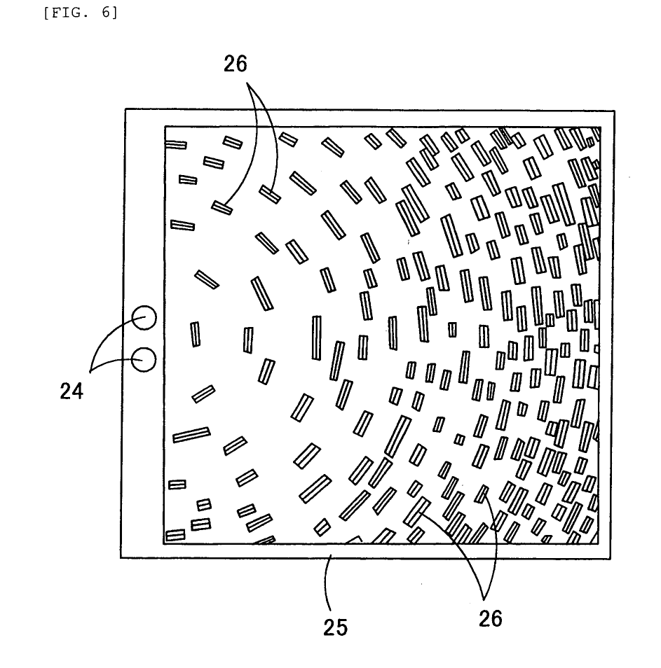

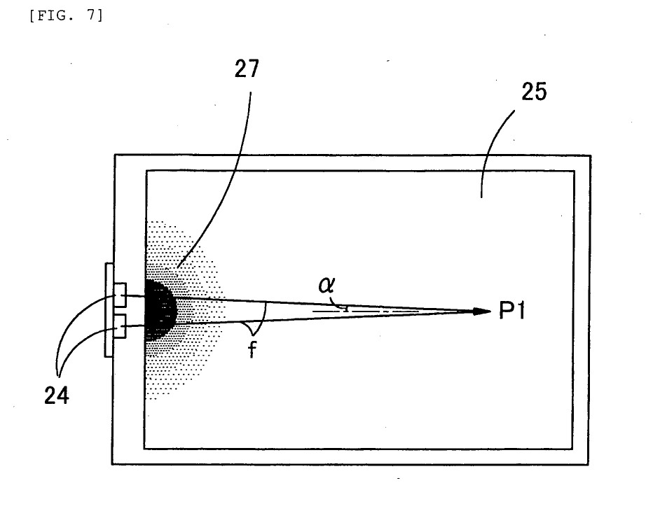

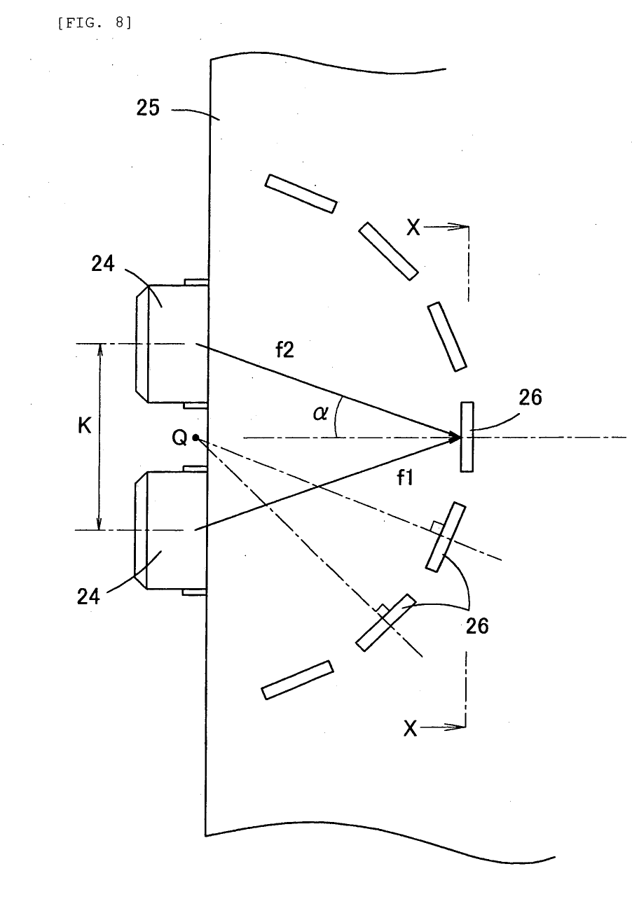

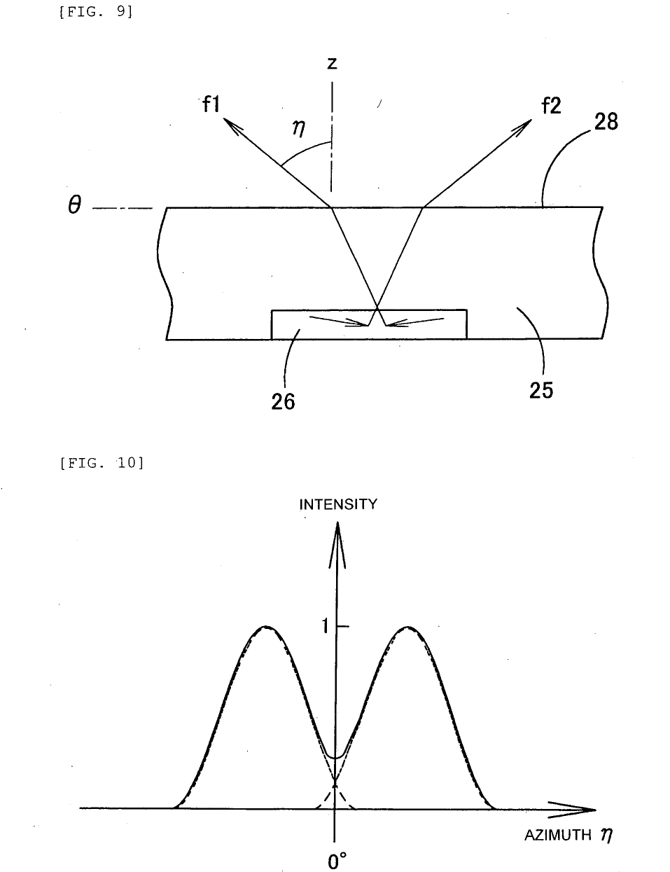

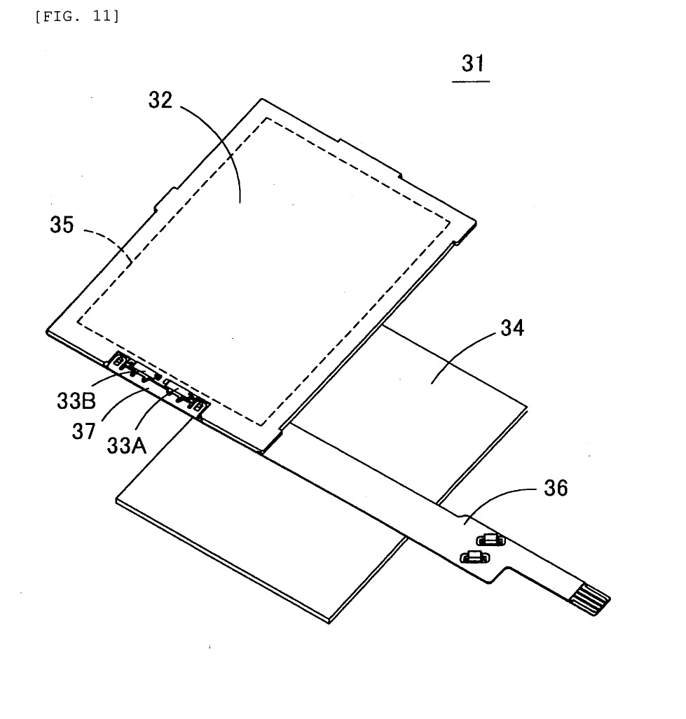

### DESCRIPTION OF REFERENCE NUMERALS

31: surface light source device
32: light guiding plate
33A, 33B: light sources
34: reflection sheet
35: deflection pattern region
37: bracket
53A, 53B: deflection pattern elements
54: light reflection surface
55: reentering surface
56: light exit surface
61: surface light source device
62: prism sheet
63: prism
64A, 64B: deflection pattern elements

### BEST MODE FOR CARRYING OUT THE INVENTION

Hereinafter, embodiments of this invention will be described in detail in accordance with the drawings. This invention is of course not limited to the embodiments described below.

### Embodiment 1

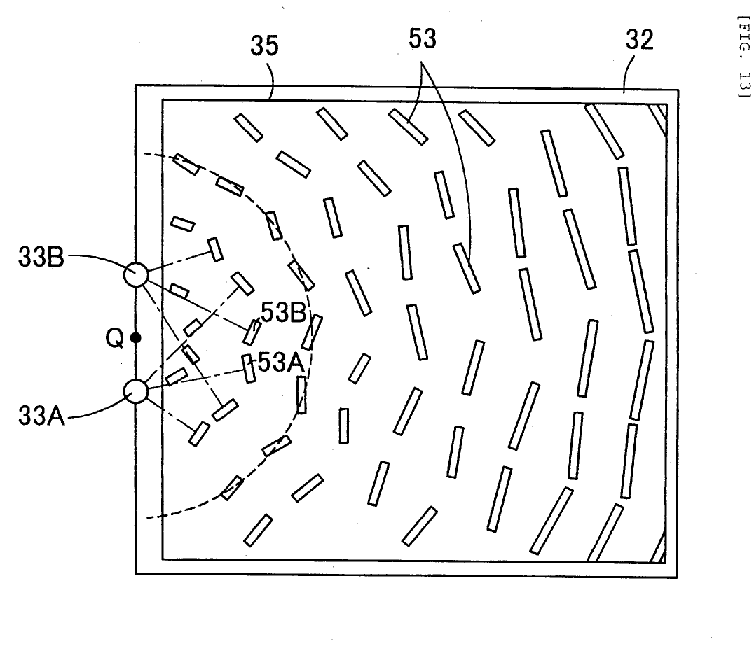

FIG. 11 is an exploded perspective view showing a surface light source device 31 according to Embodiment 1 of this invention. This surface light source device 31 is a backlight type surface light source device and formed mainly of a light guiding plate 32, light sources 33A and 33B, and a reflection sheet 34. The light guiding plate 32 is molded from a transparent resin having a high refractive index, such as a polycarbonate resin and a methacryl resin, and a deflection pattern region on which deflection pattern elements are aligned is formed on a backside of the light guiding plate 32. The surface light source device 31 is provided with the two light sources 33A and 33B. The two light sources 33A and 33B are mounted on a wiring board 36 such as an FPC (flexible printed circuit board) and a tape substrate by soldering, and electric power is supplied to the light sources 33A and 33B via the wiring board 36. The light sources 33A and 33B are fixed to the light guiding plate 32 by a bracket 37. The reflection sheet 34 is formed from an aluminum sheet or the like and has a function of returning light leaked from the backside of the light guiding plate 32 to the light guiding plate 32 by positive reflection.

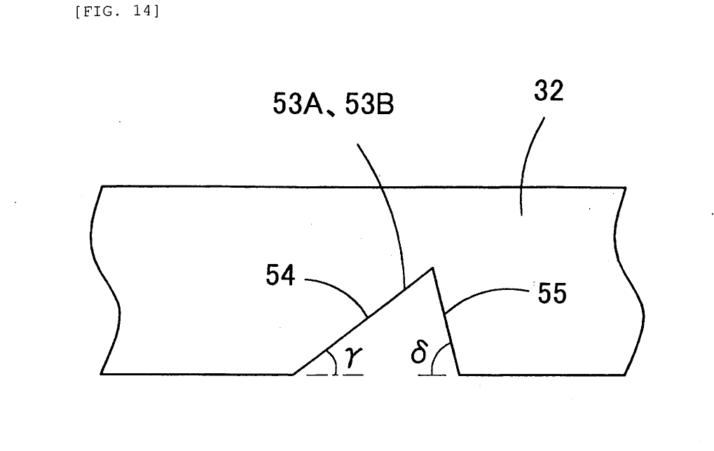

FIG. 12 is an exploded perspective view showing a structure for positioning and fixing the light sources 33A and 33B to the light guiding plate 32 by using the bracket 37. The light sources 33A and 33B are attached to a central part of one side of the light guiding plate 32. Inside each of the fine light sources 33A and 33B in the form of a block, an LED chip or a plurality of LED chips is/are sealed. On each of rear side parts of the light sources 33A and 33B a thin holding step 38 is formed.

On the central part of one side of the light guiding plate 32, two light source housings 39 for fitting the light sources 33A and 33B thereinto are provided adjacent to each other, and a part sandwiched by the light source housings 39 and outer parts of the light source housings 39 are provided with sandwiching steps 40 and 41 with a thickness equal to that of the holding steps 38 for the light sources 33A and 33B. A width of each of the light source housings 39 is substantially the same as a width of each of the light sources 33A and 33B, and a projection 42 is formed on one side surface of each of the light source housings 39. Therefore, when the light sources 33A and 33B are pressed into the light source housings 39 of the light guiding plate 32, each of the projections 42 elastically contact one side surface of each of the light sources 33A and 33B to press the other side surfaces of the light sources 33A and 33B against side surfaces of the light source housings 39. Thus, the light sources 33A and 33B are stably retained in the light source housings 39 to achieve positioning of each of the light sources 33A and 33B in the width direction.

An abutting part 43 is projected from each ends of an abutting surface of each of the light source housings 39, and front surfaces of the light sources 33A and 33B are abutted to the abutting parts 43 when the light sources 33A and 33B are pressed into the light source housings 39. When the light sources 33A and 33B are abutted to the abutting parts 43, positioning of the light sources 33A and 33B in an anteroposterior direction is achieved while ensuring a fine gap 44 between the front surface of each of the light sources 33A and 33B and each of the abutting surfaces of the light source housings 39. Further, the light guiding plate 32 is provided with bracket mounting parts 45 having a thickness same as that of the sandwiching steps 41 and formed in such a fashion as to continue from the sandwiching steps 41 as well as snaps (retainer parts) 46 projected from an upper surface and a lower surface of each of the bracket mounting parts 45. A slope inclined frontward is formed on a front part of each of the snaps 46.

The light sources 33A and 33B fitted into the light source housings 39 of the light guiding plate 32 are fixed to the light guiding plate 32 by the bracket 37. The bracket 37 is manufactured by punching a metal material such as a stainless steel plate, a steel plate, and an aluminum plate and then bending the thus-obtained metal plate and has a diphycercal and symmetrical shape. The bracket 37 is bent with a gap being so defined as to bring the bracket 37 into a U-shape, and a height between an upper piece and a lower piece is the same as a length from the upper surface and the lower surface of each of the holding steps 38 for the light sources 33A and 33B, the sandwiching steps 40 and 41 for the light guiding plate 32, and the bracket mounting parts 45.

A mounting piece 47 is provided at each of ends of each of the upper and the lower pieces of the bracket 37, and a locking hole 48 which is a square hole slightly larger than the snap 46 is formed on each of the mounting pieces 47. A holding piece 49 for both of the upper and the lower pieces is provided at a central part between the right and left mounting pieces 47, and an abutting piece 50 for both of the upper and the lower pieces is provided on each sides of the holding piece 49. A holding piece 51 for both of the upper and the lower pieces is provided between the abutting piece 50 and the mounting piece 47. Further, a slit 52 is formed between the mounting piece 47 and the holding piece 51, between the holding piece 51 and the abutting piece 50, and between the abutting piece 50 and the holding piece 49. The slits 52 make it easier for the bracket 37 to be elastically bent.

The bracket 37 having the above-described structure is mounted after the light sources 33A and 33B are fitted into the light source housings 39 in such a manner that the bracket 37 holds the light sources 33A and 33B and the light guiding plate 32 from above and below. That is, after fitting the sandwiching steps 41 of the light guiding plate 32 and one of the holding steps 38 of each of the light sources 33A and 33B between the holding pieces 51 of the bracket 37 and fitting the sandwiching step 40 of the light guiding plate 32 and the other holding step 38 of each of the light sources 33A and 33B between the holding pieces 49 of the bracket 37, the mounting pieces 47 are pressed with each of the bracket mounting parts 45 being sandwiched between the corresponding mounting pieces 47, so that the bracket 37 is fixed to the light guiding plate 32 when the snaps 46 are locked by the locking holes 48. As a result, the bracket 37 is positioned in a longitudinal direction by sandwiching the sandwiching steps 40 and 41 of the light guiding plate 32 and achieves positioning of the light sources 33A and 33B in the longitudinal direction by sandwiching the sandwiching steps 38 of the light sources 33A and 33B, thereby achieving positioning of the light sources 33A and 33B with respect to the light guiding plate 32 in the longitudinal direction. Also, since the abutting pieces 50 of the bracket 37 are abutted to the rear surfaces of the light sources 33A and 33B, the bracket 37 is elastically warped, and the light sources 33A and 33B are pressed against the abutting parts 43 of the light guiding plate 32 by the elastic repulsion, thereby ensuring the positioning of the light sources 33A and 33B in the anteroposterior direction. As a result, the light sources 33A and 33B are positioned in the longitudinal, horizontal, and anteroposterior directions inside the light source housings 39 of the light guiding plate 32.

FIG. 13 is a diagram illustrating layout of the deflection pattern elements 53A and 53B provided in the deflection pattern region 35 on the lower surface of the light guiding plate 32. The LED chip sealed inside each of the light sources 33A and 33B has the size of about 0.3 mm, and each of the light sources 33A and 33B inside which the LED chip is sealed with a resin has a width of about 2.2 mm. A distance between the light sources 33A and 33B is about 4.1 mm. Therefore, it is difficult to treat such light sources 33A and 33b as one point light source. Accordingly, the deflection pattern elements 53A and 53B has the layout shown in FIG. 13. The deflection pattern elements 53A and 53B are disposed on concentric circles having its center at the middle point Q between the light sources 33A and 33B. The deflection pattern elements disposed on the concentric circles are aligned in such a fashion that the deflection pattern element 53A disposed at a right angle with respect to a direction connecting the deflection pattern element 53A and one of the light source 33A and the deflection pattern element 53B disposed at a right angle with respect to a direction connecting the deflection pattern element 53B and the other light sources 33B are alternated. To be precise, each of the deflection pattern elements 53A which are a part of the deflection pattern elements disposed on the concentric circles is disposed in such a fashion that a normal to a light reflection surface thereof is substantially parallel to the direction connecting the light source 33A and the deflection pattern element 53A when viewed from a direction perpendicular to the light exit surface of the light guiding plate 32, and each of the deflection pattern elements 53B which are the rest of the deflection pattern elements is disposed in such a fashion that a normal to a light reflection surface thereof is substantially parallel to the direction connecting the light source 33B and the deflection pattern element 53B when viewed from a direction perpendicular to the light exit surface of the light guiding plate 32. Also, on one concentric circle, each of the deflection pattern element 53A and 53B is disposed in such a fashion that the direction oriented from each of the deflection pattern elements 53A and 53B to the corresponding light source 33A or 33B forms a right angle with a length direction thereof, and the deflection pattern elements 53A and 53B disposed at right angles with the light sources 33A or 33B are alternated.

To be precise, the direction of the light source 33A which is used as a reference in deciding the layout of the deflection pattern elements 53A and 53B means a direction of positions of light emission points (LED chips) of the light sources 33A and 33B. In the case where there are plural light emission points in the deflection pattern elements 53A an 53B, the direction is set to a direction of a middle point of all the light emission points in the deflection pattern elements 53A and 53B. Note that it is not problematic if the direction connecting each of the deflection pattern elements 53A and 53B and the corresponding one of the light sources 33A and 33B is shifted from the light emission points or the middle point in the range of the size of the deflection pattern elements 53A and 53B.

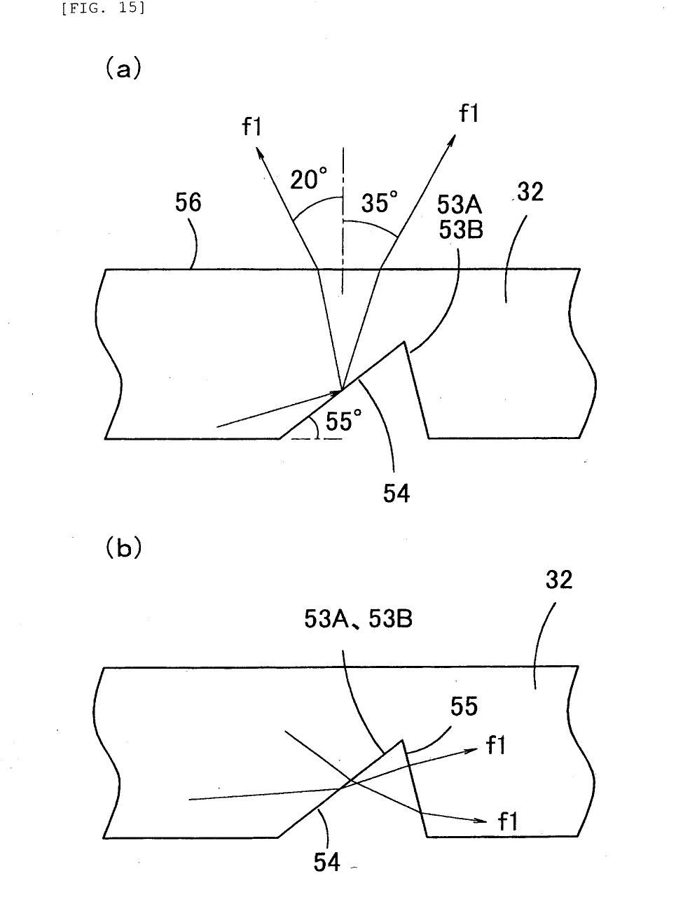

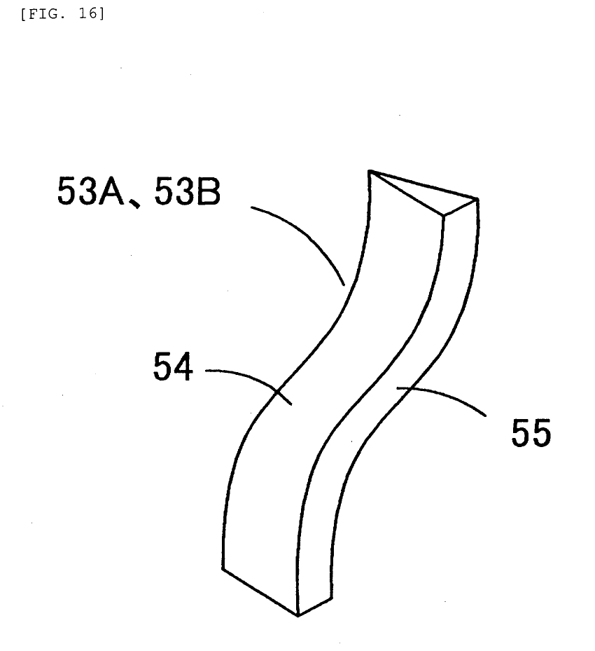

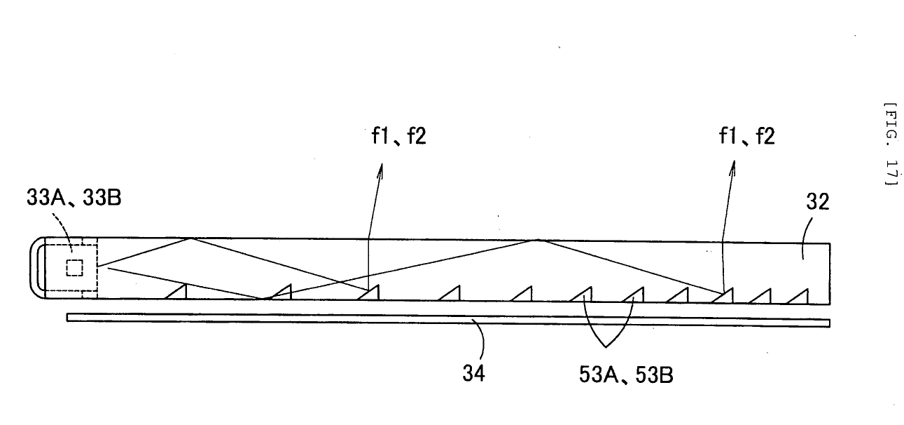

FIGS. 14, 15(a), and 15(b) are diagrams illustrating a section and a function of the deflection pattern elements 53A and 53B. As shown in FIG. 14, each of the deflection pattern elements 53A and 53B has the shape of a recessed triangle prism of which a section is in the form of a triangle, and the section is substantially uniform in the length direction. Each of the deflection pattern elements 53A and 53B has a light reflection surface 54 which is a slope facing to the corresponding one of the light sources 33A and 33B, and a slope distant from the light source 33A or 33B is a reentering surface 55. The section of each of the deflection pattern elements 53A and 53B is substantially in the form of a right-angle triangle, and it is desirable that an inclination angle γ of the light reflection surface 54 and an inclination angle δ of the reentering surface 55 satisfy the following relationship.

γ<δ

45°≦γ≦65°

80°≦δ≦90°

In the case where the refractive index of the light guiding plate 32 is n=1.53, for example, when the inclination angle of the light reflection surface 54 is set to γ=56°, light entered to each of the deflection pattern elements 53A and 53B from the backside is totally reflected by the light reflection surface 54 to exit from the light exit surface 56 at an angle in the range of ξ=−20° to 35° as viewed from a θ axis. Also, as shown in FIG. 15(b), in the case where the light entered the light reflection surface 54 is leaked from the light reflection surface 54 after passing through the light reflection surface 54, the light is guided again to the light guiding plate 32 from the reentering surface 55, so that a light amount loss is reduced. In the case where the leaked light does not reenter the light guiding plate 32 from the reentering surface 55, the leaked light is reflected by the reflection sheet 34 to return to the light guiding plate 32.

The deflection pattern elements 53A and 53B are not necessarily extended linearly in the length direction and may be slightly wavy or curved. For example, the deflection pattern elements 53A and 53B may be substantially S-shaped as shown in FIG. 16. The reason for the curving of the deflection pattern elements 53A and 53B is that it is possible to widen the directivity characteristic of the light emitted from the surface light source device by the curvature of the deflection pattern elements 53A and 53B in the case where the directivity characteristic is narrow. When the deflection pattern elements 53A and 53B are curved, a normal to the light reflection surface differs depending on the position of the light reflection surface. In such case, a direction which is substantially the center of directions of normals to the reflection surface is oriented to either one of the light sources.

Therefore, in this surface light source device 31, the lights from the light sources 33A and 34B exit from the light exit surface 56 as shown in FIG. 17. Referring to FIG. 17, the lights f1 and f2 emitted from the light sources 33A and 33B enter the light guiding plate 32 to be totally reflected between the light exit surface of the light guiding plate 32 and a surface opposed to the light exit surface and then are oriented in a radial fashion from the light sources 33A and 33B. The lights entered the deflection pattern elements 53A and 53B are reflected by the light reflection surfaces 54 to exit from the light exit surface 56 to the direction substantially perpendicular.

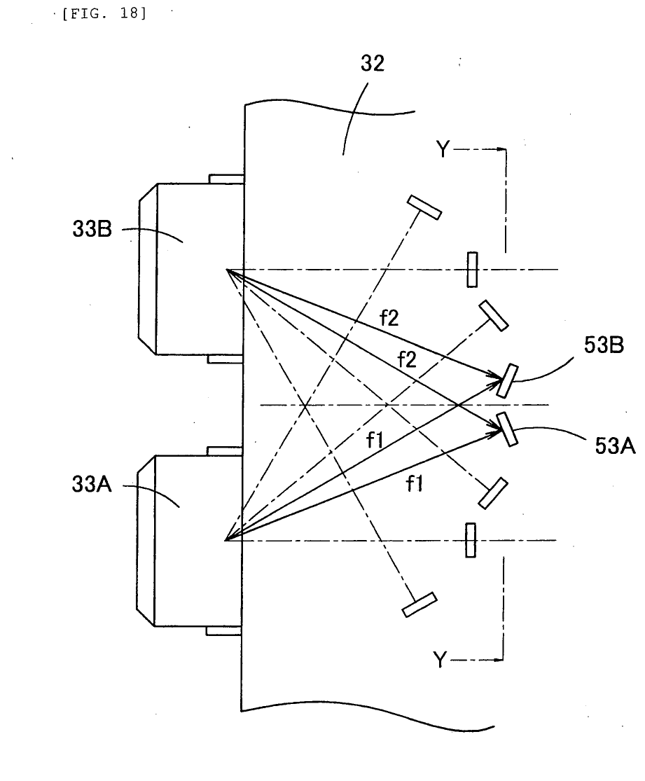

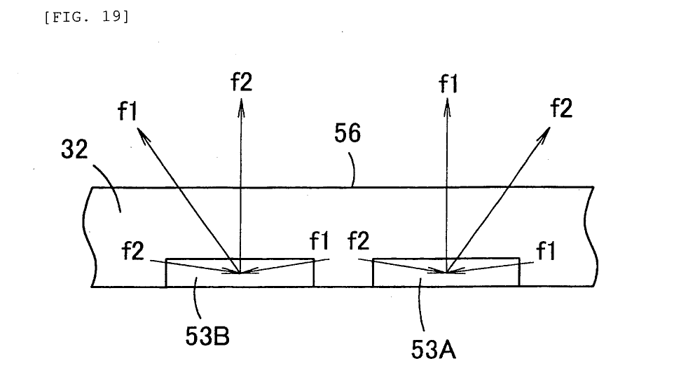

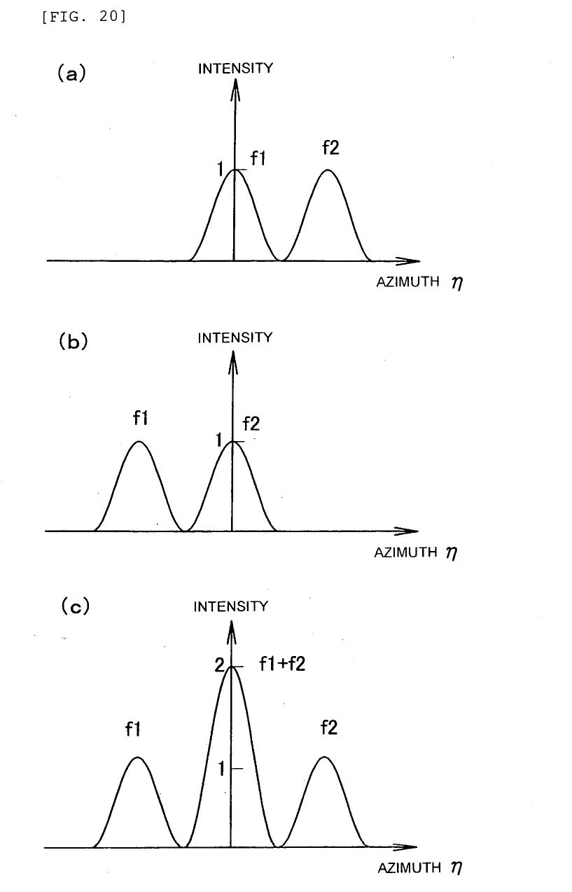

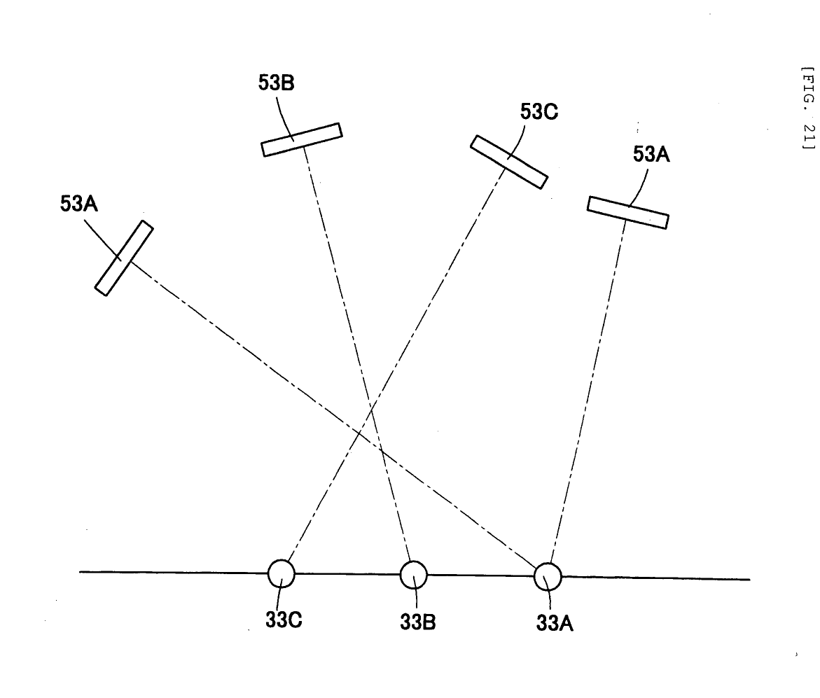

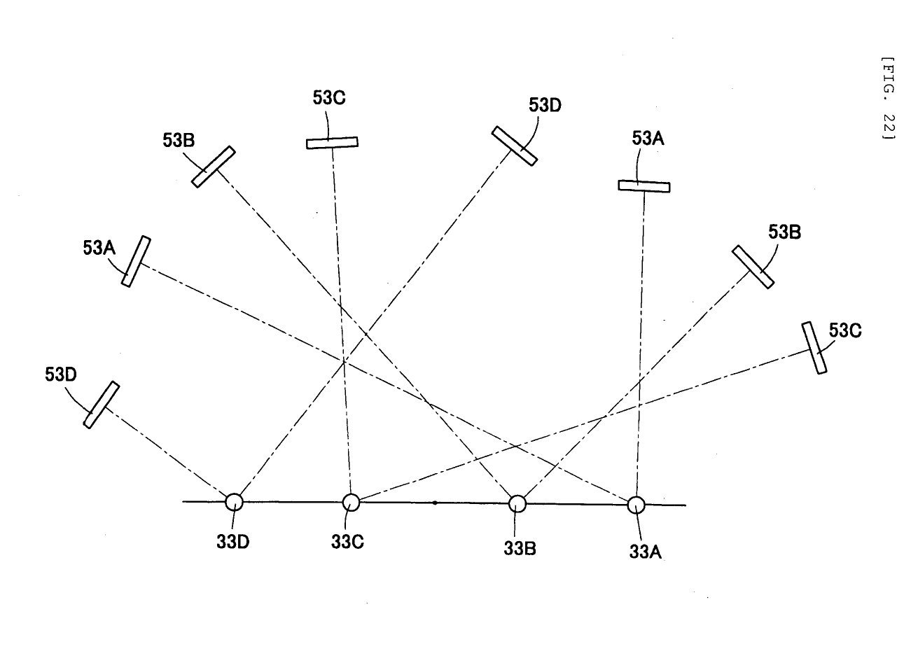

FIGS. 18 and 19 are diagrams illustrating a directivity characteristic in the case where the lights exit from the light exit surface 56. FIG. 18 is a schematic plan view showing an enlarged view of the vicinity of the light sources 33A and 33B. FIG. 19 is a sectional view taken along the line Y-Y of FIG. 18, wherein a plane perpendicular to an r-axis in the vicinity of the light sources (plane parallel to a z-θ plane) is shown. As shown in FIG. 18, in the deflection pattern element 53A corresponding to the light source 33A, the light f1 emitted from the light source 33A enters perpendicularly as viewed from the z-axis (herein after referred to as “in plan view”), the light f2 emitted from the other light source 33B enters obliquely. Therefore, as shown in FIG. 19, in the zθ-plane, the light f1 reflected by the deflection pattern element 53A exits from the light exit surface 56 to a substantially perpendicular direction, and the light f2 reflected by the deflection pattern element 53A exits from the light exit surface 56 to an oblique direction. Accordingly, the directivity characteristic of the light exiting from the light exit surface 56 after being reflected by the deflection pattern element 53A is as shown in FIG. 20(a) and has peaks in the direction perpendicular to the light exit surface 56 (η=0°) and the direction oblique to the light exit surface 56 (η>0°).

Also, as shown in FIG. 18, in the deflection pattern element 53B corresponding to the light source 33B, the light f2 emitted from the light source 33B enters perpendicularly in plan view, and the light f1 emitted from the other light source 33A enters obliquely. Therefore, as shown in FIG. 19, in the zθ-plane, the light f2 reflected by the deflection pattern element 53B exits from the light exit surface 56 to a substantially perpendicular direction, and the light f1 reflected by the deflection pattern element 53B exits from the light exit surface 56 to an oblique direction. Accordingly, the directivity characteristic of the light exiting from the light exit surface 56 after being reflected by the deflection pattern element 53B is as shown in FIG. 20(b) and has peaks in the direction perpendicular to the light exit surface 56 (η=0°) and the direction oblique to the light exit surface 56 (η<0°).

As a result, the directivity characteristic of the whole lights exiting from the light exit surface 56 after being reflected by the deflection pattern elements 53A and 53B is as shown in FIG. 20(c). The directivity characteristic of FIG. 20(c) is obtain able by overlapping the directivity characteristic of FIG. 20(a) and the directivity characteristic of FIG. 20(b) and has three peaks. Particularly, a large amount of outgoing light is obtained in the direction substantially perpendicular to the light exit surface 56. In the case where ideal deflection pattern elements 53A and 53B are used, 50% of the light emitted from the light sources 33A and 33B is oriented to the frontward direction in the vicinity of the light sources 33A and 33B.

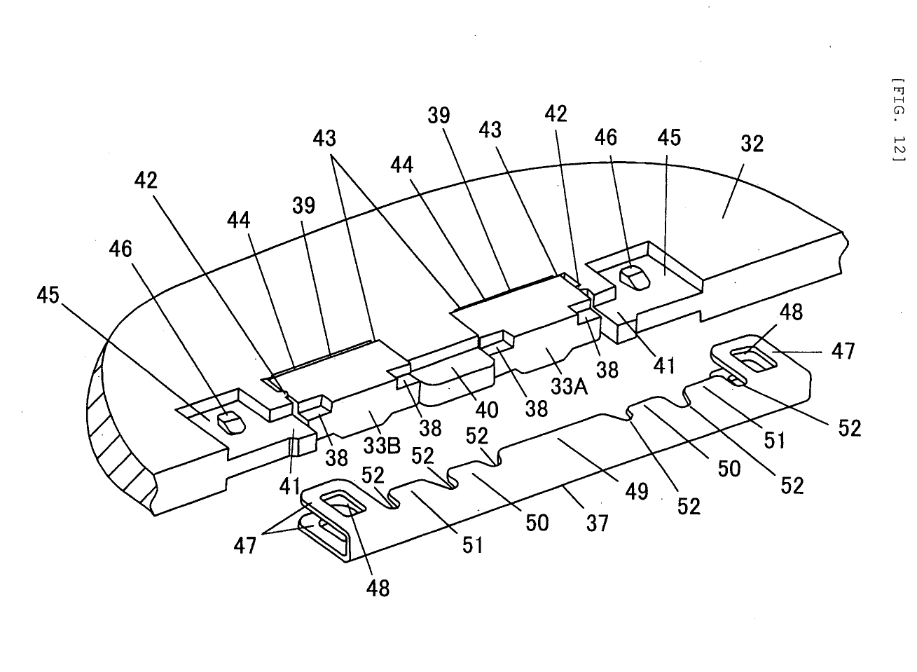

As a comparison between the above directivity characteristic and the conventional directivity characteristic showing in FIG. 10, the directivity characteristic of the conventional example has two peaks in the vicinity of the light source, and an amount of light oriented to the frontward direction of the surface light source is considerably small, thereby failing to obtain brightness in the vicinity of the light source. In contrast, in the case of the surface light source device of this invention, the amount of light oriented to the frontward direction of the surface light source device is increased with a reduction in brightness being suppressed in the vicinity of the light sources 33A and 33B as shown in FIG. 20(c). Therefore, with the use of the plural light sources, the reduction in brightness hardly or never occurs in the vicinity of the light sources, thereby improving uniformity in brightness in the light emission region of the surface light source device. Consequently, according to this embodiment, it is possible to increase the brightness of the surface light source device with a loss of lights emitted from the light sources being suppressed as well as to achieve uniformity of brightness in the overall light emission region.

In the case of a measurement at a position 5.5 mm from the light source, intensity at the front when the peak intensity was set to 1 with the directivity characteristic of FIG. 10 was 3.7%. In contrast, in the surface light source device of this embodiment having the characteristic shown in FIG. 20(c), intensity at the front when the peak intensity is set to 1 was 32.7%. Thus, the surface light source device of this invention enables to achieve the efficiency of more than 9 times that of the conventional example having the directivity characteristic shown in FIG. 10 as well as to prevent the reduction in brightness in the vicinity of the light sources. Also, in view of the overall light emission region of the surface light source device, it was confirmed that the surface light source device of this invention achieves the effect of improving the efficiency by 10% or more.

Though the deflection pattern element 53A disposed at the right angle with respect to the light source 33A and the deflection pattern element 53B disposed at the right angle with respect to the light source 33B are alternated in the above-described embodiment, the deflection pattern elements 53A and 53B may be disposed with regularity or at random. The directivity characteristic is uniform over the whole surface light source device when the deflection pattern elements 53A and 53B are distributed at a constant rate in the very small region which is sufficiently smaller than the deflection pattern region 35 of the surface light source device and sufficiently larger than the deflection pattern elements 53A and 53B.

Also, since the amount of light reaching to the lights guiding plate is reduced with an increase in distance from the light sources 33A and 33B, it is possible to achieve the uniform brightness in the overall light exit surface by reducing a pattern density of the deflection pattern elements 53A and 53B in the vicinity of the light sources 33A and 33B and increasing the pattern density of the deflection pattern elements 53A and 53B in accordance with the increase in distance from the light sources.

The two types of the deflection pattern elements 53A and 53B are constantly distributed in this embodiment. Though it is possible to dispose the deflection pattern elements 53A and 53B separately in different regions, a boundary between the different deflection pattern elements can be distinct and a brightness line and a dark line can be generated.

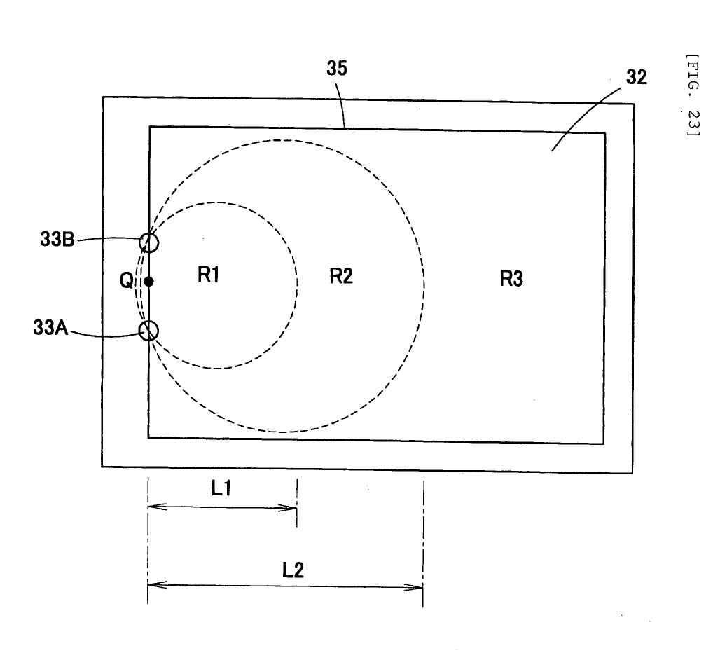

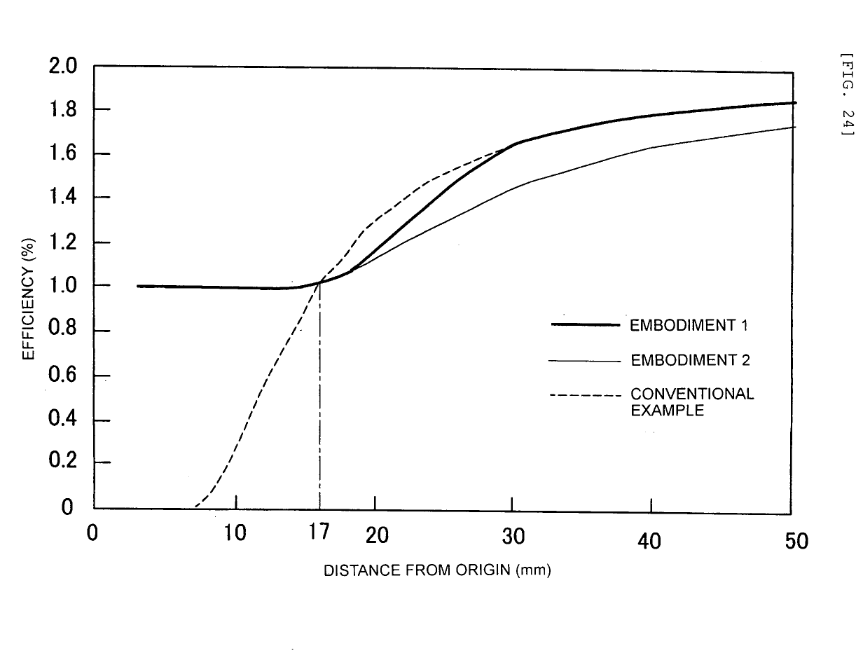

Though the case of using the two light sources 33A and 33B is described in Embodiment 1, the number of light sources may be three or more. Shown in FIG. 21 is one example of using three light sources 33A, 33B, and 33C, and deflection pattern elements 53A, 53B, and 53C are disposed in this order repeatedly on concentric circles of which the center is a middle point Q of the light sources 33A, 33B, and 33C. In plan view, a direction of a normal to the deflection pattern element 53A is substantially parallel to a direction connecting the element 53A and the light source 33A. Likewise, in plan view, a direction of a normal to the deflection pattern element 53B is substantially parallel to a direction connecting the element 53B and the light source 33B. In plan view, a direction of a normal to the deflection pattern element 53C is substantially parallel to a direction connecting the element 53C and the light source 33C. Also, shown in FIG. 22 is one example of the case of using four light sources 33A, 33B, 33C, and 33D, and deflection pattern elements 53A, 53D, 53C, and 53B corresponding to the light sources 33A, 33D, 33C and 33B are disposed in this order repeatedly on concentric circles of which the center is a middle point Q of the light sources 33A, 33B, 33C, and 33D.

Note that the increase in number of the light sources to three or more is useful for the case of combining light sources that are different in color of light to be emitted and the case of widening a visual field characteristic in preference to increasing the brightness.

### Embodiment 2

FIG. 23 is a diagram illustrating Embodiment 2 of this invention. In the same manner as in Embodiment 1, in a surface light source device of Embodiment 2, in a region R1 inside a circle passing on light sources 33A and 33B and a point at a distance L1 (=17 mm) from a middle point Q, deflection pattern elements 53A disposed concentrically around the light source 33A and deflection pattern elements 53B disposed concentrically around the other light source 33B are mixedly provided. Also, in a region R3 outside a circle passing on the light sources 33A and 33B and a point at a distance L2 (=30 mm) from the middle point Q, the deflection pattern elements 53A and 53B are disposed concentrically around the middle point of the light sources 33A and 33B in the same manner as in the conventional example. In a region R2 having a crescent shape and positioned outside the region R1 and inside the region R3, layout of the deflection pattern elements 53A and 53B transitions gradually from the pattern of the region R1 to the pattern of the region R2. For example, in the region R2, a point at which directions perpendicular to the deflection pattern elements 53A and 53B disposed on the circle intersect with each other moves toward the middle point Q from the light sources 33A and 33B as the position of the deflection pattern elements 53A and 53B approach from the region R1 to the region R3.

FIG. 24 is a diagram showing a relationship between the distance from the light sources 33A and 33B and light use efficiency. In FIG. 24, light use efficiencies of the case of mixing the deflection pattern elements 53A disposed concentrically around the light source 33A and the deflection pattern elements 53B disposed concentrically around the light source 33B (Embodiment 1), the case of providing in the whole deflection pattern region the deflection pattern elements disposed concentrically around the middle point Q between the light sources (conventional example), and the case of Embodiment 2 shown in FIG. 21 are shown. As is apparent from FIG. 22, the efficiency of Embodiment 1 is higher than that of the conventional example in the vicinity of the light sources, and the efficiency of the conventional example is higher than that of Embodiment 1 in the region distant from the light sources. Therefore, it is possible to improve the light use efficiency in the whole deflection pattern region 35 by mixing the deflection pattern elements 53A and 53B disposed concentrically around the light sources 33A and 33B as in Embodiment 1 in the region (R1) close to the light sources 33A and 33B and disposing the deflection pattern elements 53A and 53B concentrically around the middle point Q in the region (R3) distant from the light sources 33A and 33B as in Embodiment 2. However, since the boundary between the different regions in the layout of the deflection pattern elements 53A and 53B can be distinct or a bright line and a dark line can be generated on the boundary when the layout of the deflection pattern elements 53A and 53B is changed sharply, the region R2 is provided between the region R1 and the region R3 in Embodiment 2, so that the pattern is gradually changed from the pattern of the region R1 to the pattern of the region R3 in the region R2.

### Embodiment 3

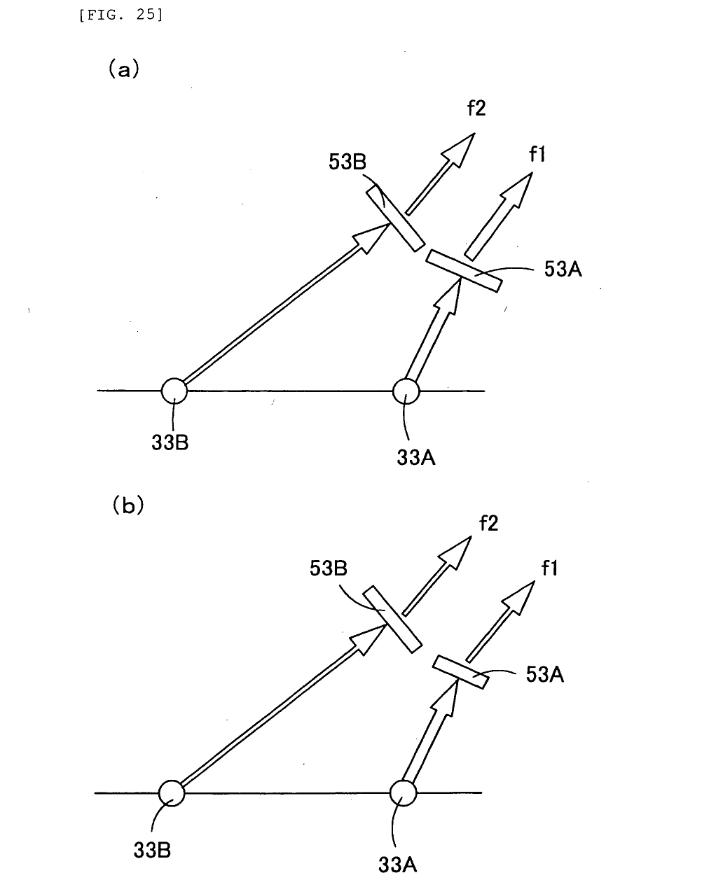

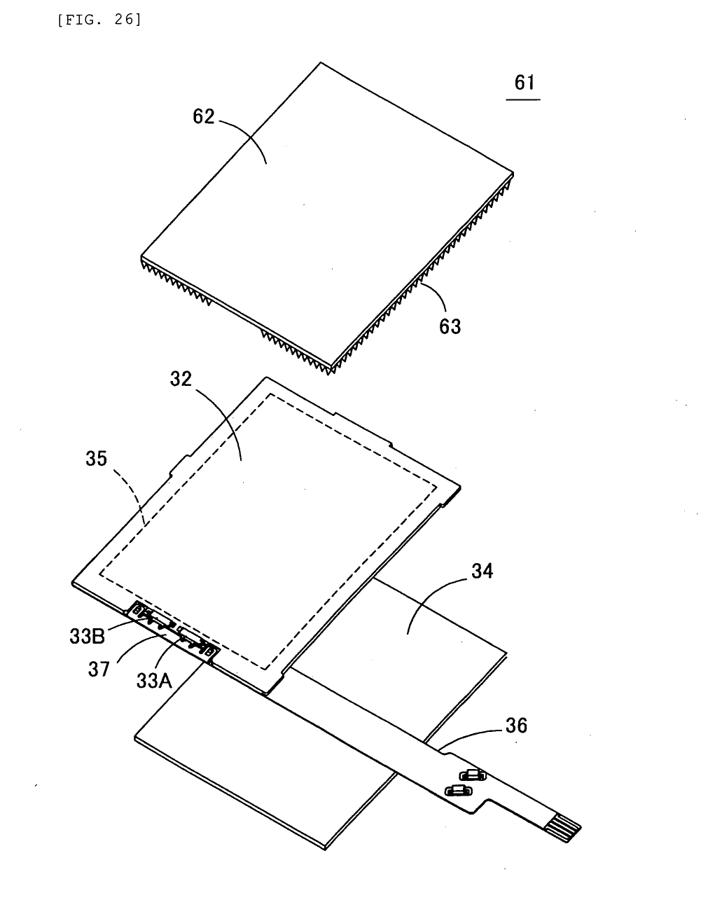

FIGS. 25(a) and 25(b) are diagrams illustrating a structure of Embodiment 3. Embodiment 3 is an improvement example of the surface light source device of Embodiment 1 or Embodiment 2. As shown in FIG. 25(a), since a distance from the light source 33A to the deflection pattern element 53A differs from a distance from the light source 33B to the deflection pattern element 53B with the use of the two light sources even when the deflection pattern elements 53A and 53B are adjacent to each other, incident intensity f1 of light emitted from the light source 33A to the deflection pattern element 53A differs from incident intensity f2 of light emitted from the light source 33B to the deflection pattern element 53B. Therefore, in the adjacent deflection pattern elements, intensity of light f1 exiting perpendicularly from the deflection pattern element 53A differs from intensity of light f2 exiting perpendicularly from the deflection pattern element 53B, thereby raising possibility of generation of a pattern of brightness and darkness in a light emission region of the surface light source device or a generation of a moiré pattern when used for a liquid crystal display apparatus.

Accordingly, in Embodiment 3, each of the deflection pattern elements 53A corresponding to the light source 33A is increased in length with an increase in distance from the light source 33A (area of the light reflection surface 54 is increased) so that light reflectance by the deflection pattern elements 53A is increased with the increase in distance from the light source 33A. Likewise, each of the deflection pattern elements 53B corresponding to the light source 33B is increased in length with an increase in distance from the light source 33B, so that a light reflectance by the deflection pattern elements 53B is increased with the increase in distance from the light source 33B.

As a result, when the deflection pattern element 53A and the deflection pattern element 53B are adjacent to each other as shown in FIG. 25(b), the deflection pattern element 53A which is close to the light source 33A is reduced in length, and the deflection pattern element 53B distant from the light source 33B is increased in length. As a result, when an amount of light entering the deflection pattern element 53A is large and an amount of light entering the deflection pattern element 53B is small, the intensity of the light f1 reflected by the deflection pattern element 53A and exiting perpendicularly from the light exit surface is substantially the same as the intensity of the light f2 reflected by the deflection pattern element 53B and exiting from the light exit surface. Therefore, according to Embodiment 3, it is possible to suppress the generation of the pattern of darkness and brightness in the surface light source device and the generation of the moiré pattern in the liquid crystal display apparatus.

In order to balance the light amounts, the pattern density of the deflection pattern elements 53A and 53B may be increased with an increase in distance from the light sources 33A and 33B. However, with such method, the pattern density of the deflection pattern elements 53A and 53B is remarkably reduced in the vicinity of the light sources 33A and 33B to undesirably cause the pattern to be visible. In contrast, by reducing the length of the deflection pattern elements 53A and 53B without reducing the pattern density of the deflection pattern elements 53A and 53B in the vicinity of the light sources 33A and 33B, it is possible to solve the above problems. Therefore, the structure of Embodiment 3 is useful particularly in the vicinity of the light sources 33A and 33B.

### Embodiment 4

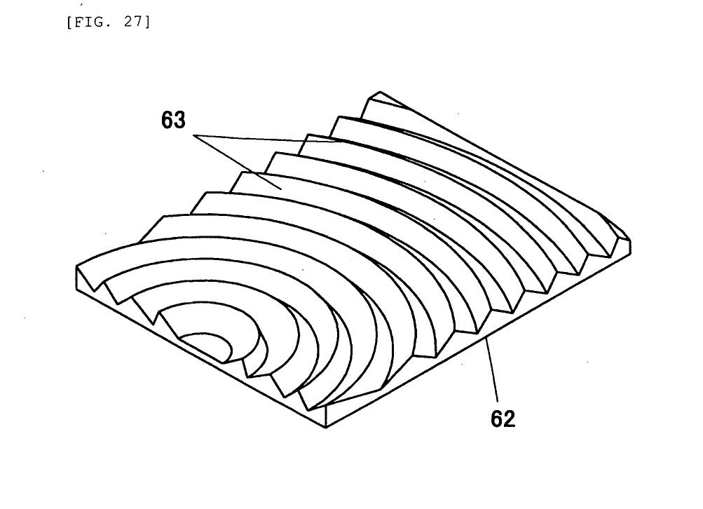

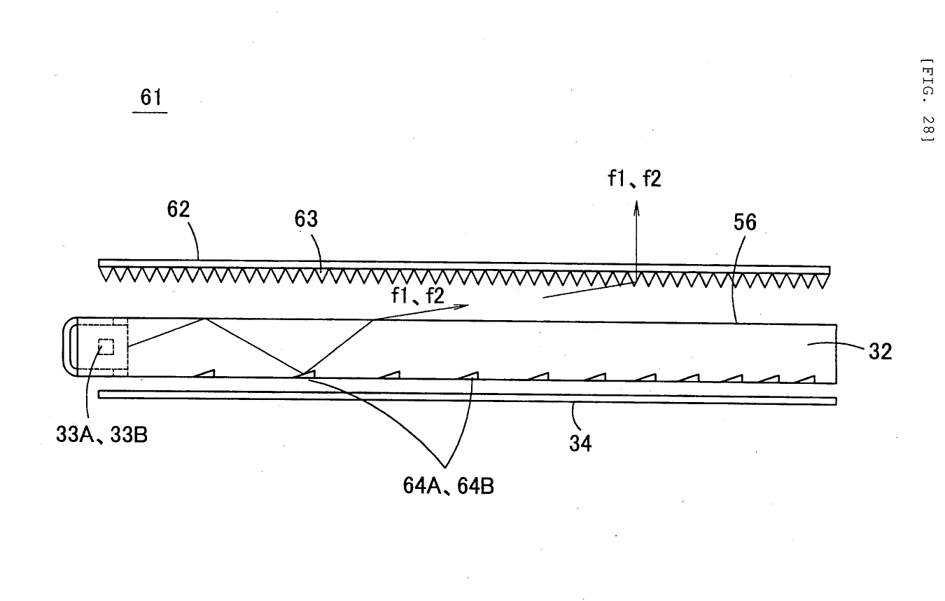

FIG. 26 is an exploded perspective view showing a surface light source device 61 according to Embodiment 4 of this invention. This surface light source device 61 is mainly formed of a light guiding plate 32, light sources 33A and 33B, a reflection sheet 34, a bracket 37, and a prism sheet 62. On the lower surface of the prism sheet 62, prisms 63 each being in the form of a circular arch as shown in FIG. 27 are provided concentrically around a common point. In an assembled state, the center of the circular arches of the prisms 63 disposed on the prism sheet 62 substantially overlaps with a middle point Q of the light sources 33A and 33B in plan view. The two types of the deflection pattern elements 64A and 64B are provided in a deflection pattern region 35 on the lower surface of the light guiding plate 32 in this surface light source device 61, and an inclination angle γ of a light reflection surface of the deflection pattern elements is about 12°.

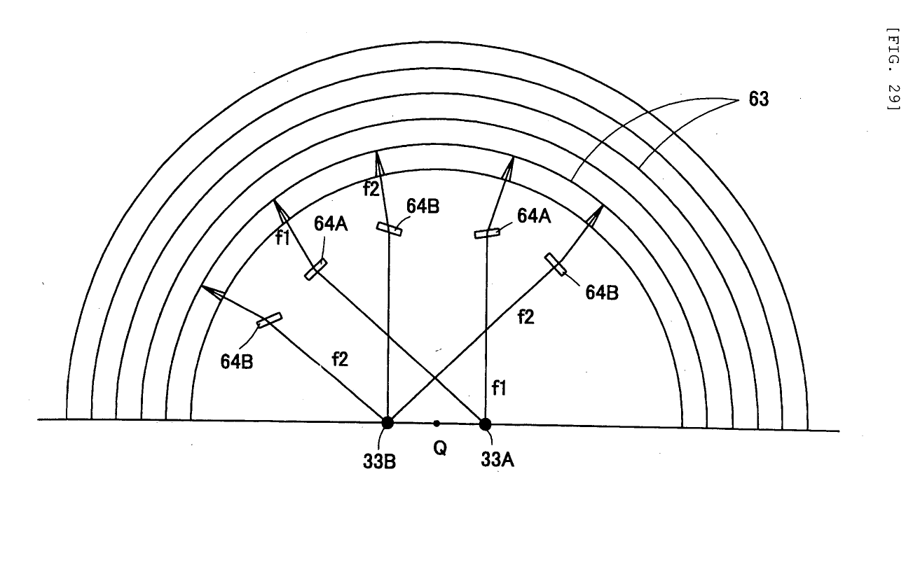

FIG. 28 is a schematic sectional view illustrating behavior of lights in the surface light source device 61. In the surface light source device 61, lights f1 and f2 emitted from the light sources 33A and 33B enter the light guiding plate 32 to be reflected by light exit surface 56 and a surface reverse to the light exit surface 56 when passing through the light guiding plate 32. The lights f1 and f2 passing through the light guiding plate 32 are totally reflected by the light reflection surfaces of the deflection pattern elements 64A and 64B to exit from the light exit surface 56 to a direction substantially parallel to the light exit surface 56. Thus, the lights f1 and f2 exited to the direction substantially parallel to the light exit surface 56 enter the prisms 63 provided on the lower surface of the prism sheet 62 to be totally reflected by slopes of the prisms 63, so that the directions of the lights are bent. Thus, the lights exit in a direction substantially perpendicular to the prism sheet 62.

In the surface light source device 61 wherein the lights behave as shown in FIG. 28, when all the deflection pattern elements are disposed concentrically around the middle point Q of the light sources 33A and 33B on the prism sheet 62, the lights exited from the light exit surface after being reflected by the deflection pattern elements enter the prisms 63 obliquely in the case where plural light sources are used. Therefore, the lights are not oriented to the perpendicular direction due to the prisms 63, so that front brightness of the surface light source device 61 is deteriorated. Particularly, in the vicinity of the light sources, the brightness is considerably reduced, thereby raising possibility of dark part generation.

In order to solve the above problem, in the surface light source device 61 according to Embodiment 4, the deflection pattern element 64A is disposed in such a fashion that the light f1 emitted from the light source 33A and exited from the light exit surface 56 after being reflected by the deflection pattern element 64A enters the prism 63 substantially perpendicularly (or in a segment direction) to a length direction of the prism 63 as shown in FIG. 29. Likewise, the deflection pattern element 64B is disposed in such a fashion that the light f2 emitted from the light source 33B and exited from the light exit surface 56 after being reflected by the deflection pattern element 64B enters the prism 63 substantially perpendicularly (or in a segment direction) to a length direction of the prism 63. Further, the deflection pattern elements 64A and the deflection pattern elements 64B are disposed on concentric circles of which the center is the middle point Q of the light sources 33A and 33B, and the deflection pattern element 64A and the deflection pattern element 64B are alternated on each of the concentric circles. As a result, the lights f1 and f2 of the light sources 33A and 33B exited from the light exit surface 56 are bent in the substantially perpendicular direction by the prisms 63, so that the front brightness of the surface light source device 61 is improved and uniformity of brightness is improved. Particularly, it is possible to prevent the generation of dark part in the vicinity of the light sources 33A and 33B.

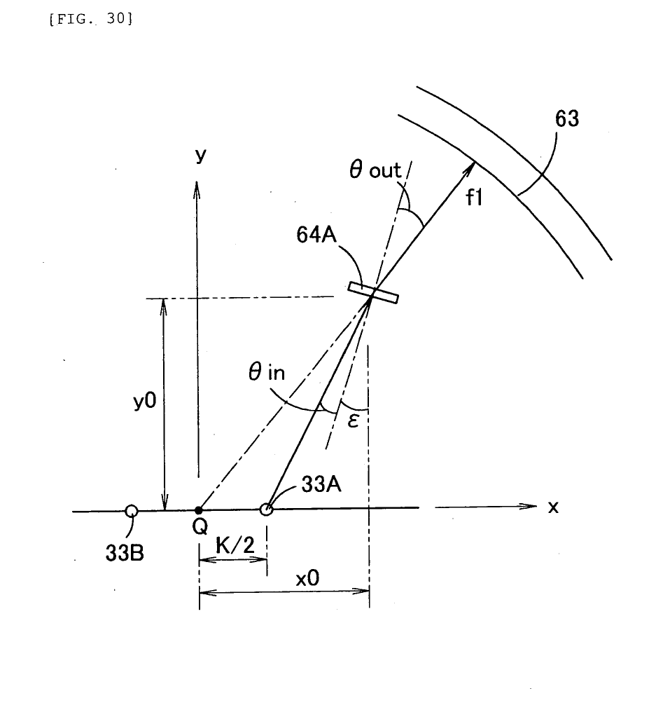

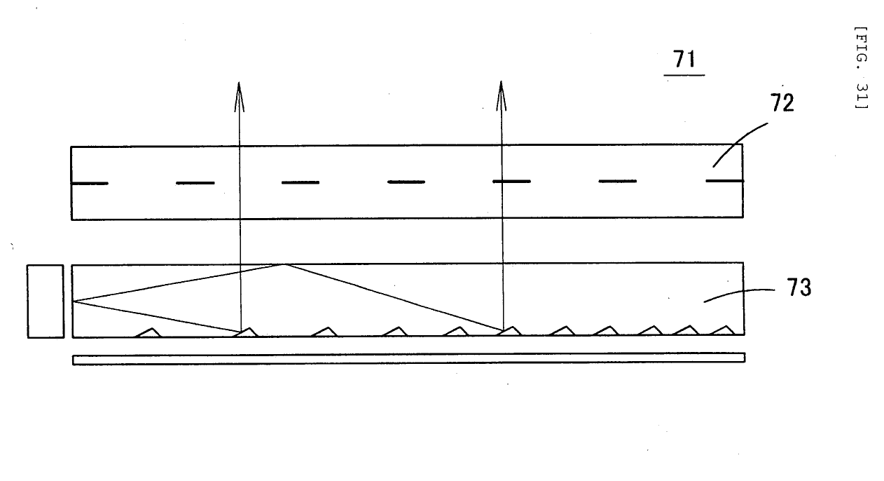

FIG. 30 is a diagram illustrating a method of deciding an angle at which each of the deflection pattern elements 64A and 64B is disposed. An incident angle and an outgoing angle to and from the light reflection surface of the deflection pattern element 64A are represented by θin and θout in plan view. In the case where the inclination angle of the light reflection surface of the deflection pattern element 64A is γ=12° and the refractive index of the light guiding plate 32 is n=1.53, the following relationship is established between the incident angle θin and the outgoing angle θout.

θout≅1.5×θin (Expression 1)

Also, the center of the circular arc of each of the prisms disposed on the prism sheet 62 overlaps with the middle point Q in plan view.

Therefore, as shown in FIG. 30, when any one of the deflection pattern elements 64A is rotated, the incident angle θin from the light source 33A changes with the rotation of the deflection pattern element 64A, and the outgoing angle θout is obtained from Expression 1. When the angle of the deflection pattern element 64A is decided in such a manner that the middle point Q is positioned on an extended line of a direction of the outgoing angle, it is possible to achieve desired positioning of the deflection pattern element 64A.

More specifically, by setting an x-axis and a y-axis by using the middle point Q as the origin as shown in FIG. 30; setting the position of any one of the deflection pattern elements 64A to (x0, y0); setting an angle formed by a direction of a normal to the deflection pattern element 64A to ε; and setting a distance between the light sources 33A and 33B to K, it is possible to decide the layout angle ε of the deflection pattern element 64A at the position (x0, y0) from the following expressions.

θout≅1.5×θin (Expression 1)

tan(ε+θin)=(x0−K/2)/y0 (Expression 2)

tan(ε+θout)=x0/y0 (Expression 3)

Though the above description is given by using the deflection pattern element 64A, the same applies to the deflection pattern element 64B (provided that K is changed to −K in Expression 2).

Accordingly, after deciding the circumference of the concentric circle of which the center is the middle point Q, the deflection pattern elements 64A and the deflection elements 64B are disposed alternately on the circumference, and then the layout angle ε is decided by the above expressions in accordance with the position (x0, y0) of each of the deflection pattern elements 64A and 64B to incline the angle of each of the deflection pattern elements 64A and 64B by the angle ε.

Though the plural light sources are disposed at the central part of the light guiding plate in the above-described embodiment, it is possible to dispose the light sources at a corner of the light guiding plate.

### Embodiment 5

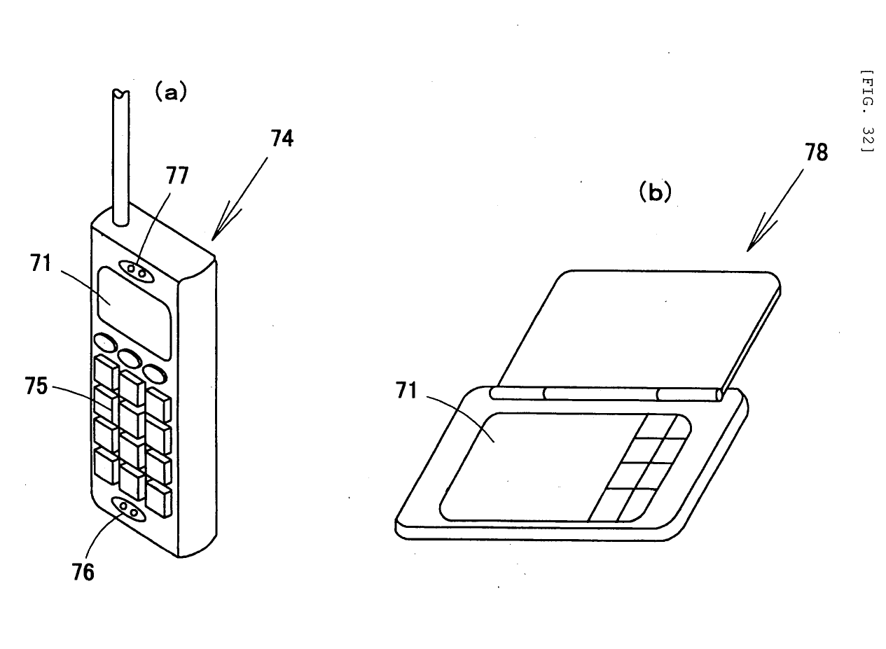

FIG. 31 is a schematic diagram showing a liquid crystal display apparatus 71 according to this invention. This liquid crystal display apparatus 71 is formed of a liquid crystal display panel 72 for generating an image by controlling light transmission and light interruption for each pixels and a surface light source device 73 according to this invention, and the surface light source device 73 is disposed on a rear surface of the liquid crystal display panel 72. Since this liquid crystal display apparatus 71 uses the surface light source device 73 according to the invention as a backlight, uniform illumination from the rear surface side of the liquid crystal display panel 72 is enabled, thereby achieving good visibility of the liquid crystal display apparatus 71. Particularly, darkening of a display screen at an end close to the light source is eliminated.

Shown in FIG. 32(a) is a mobile phone 74 using the liquid crystal display apparatus 71 as a display unit. This mobile phone has a communication function and is capable of sending voice through a microphone 76 after inputting a telephone number by using a ten-key 75 and receiving voice from a speaker 77. Shown in FIG. 32(b) is an information terminal 78 such as an electronic notebook and a mobile appliance using the liquid crystal display apparatus 71 as a display unit, the information terminal 78 having a function of processing information by using a microcomputer.

1. A surface light source device comprising a light guiding plate for drawing light introduced from a light entrance surface from a light exit surface to outside by entrapping and transmitting the light and a plurality of light sources disposed on a light entrance surface side of the light guiding plate, the surface light source device being characterized in that
a deflection pattern region comprising a plurality of deflection pattern elements disposed with a gap being defined between the adjacent deflection pattern elements is formed on a surface opposite to the light exit surface of the light guiding plate, and
the deflection pattern elements are disposed in such a fashion that: one of the deflection pattern elements corresponds to one of the light sources; another one of the deflection pattern elements corresponds to the other light source; and a normal to a light reflection surface of each of the deflection pattern elements is parallel to a direction connecting the deflection pattern element and the corresponding light source when viewed from a direction perpendicular to the light exit surface.

2. The surface light source device according to claim 1, characterized in that the deflection pattern elements corresponding to the light sources are distributed at a constant rate in an arbitrary part of the deflection pattern region which is sufficiently larger than the deflection pattern elements and sufficiently smaller than the light guiding plate.

3. The surface light source device according to claim 1, characterized in that the deflection pattern elements are increased in total area of light reflection surfaces per unit area of the light exit surface with an increase in distance between each of the deflection pattern elements and the corresponding light source.

4. The surface light source device according to claim 1, characterized in that the deflection pattern elements are disposed in such a fashion that: one of the deflection pattern elements corresponds to one of the light sources; another one of the deflection pattern elements corresponds to the other light source; and a normal to a light reflection surface of each of the deflection pattern elements is parallel to a direction connecting the deflection pattern element and the corresponding light source when viewed from a direction perpendicular to the light exit surface in the vicinity of the light sources and that the normal to the light reflection surface of each of the deflection pattern elements is parallel to a direction connecting the deflection pattern element and a central part of the light sources when viewed from the direction perpendicular to the light exit surface in a region distant from a part on which the light sources are disposed.

5. A surface light source device comprising a light guiding plate for drawing light introduced from a light entrance surface from a light exit surface to outside by entrapping and transmitting the light, a plurality of light sources disposed on a light entrance surface side of the light guiding plate, and a prism sheet opposed to the light exit surface of the light guiding plate, the surface light source device being characterized in that:
a deflection pattern region comprising a plurality of deflection pattern elements disposed with a gap being defined between the adjacent deflection pattern elements is formed on a surface opposite to the light exit surface of the light guiding plate;
a plurality of prisms are aligned on a surface of the prism sheet opposed to the light guiding plate; and
light emitted from each of the light sources transmits through the light guiding plate to be reflected by the deflection pattern element corresponding to the light source to a direction orthogonal to a length direction of the prisms when viewed from a direction perpendicular to the light exit surface and then exits outside from the light exit surface, so that the light exited from the light exit surface is reflected by the prisms after entering the prisms to be deflected to a direction perpendicular to the prism sheet.

6. The surface light source device according to claim 5, characterized in that the deflection pattern elements corresponding to the light sources are distributed at a constant rate in an arbitrary part of the deflection pattern region which is sufficiently larger than the deflection pattern elements and sufficiently smaller than the light guiding plate.

7. The surface light source device according to claim 5, characterized in that the deflection pattern elements are increased in total area of light reflection surfaces per unit area of the light exit surface with an increase in distance between each of the deflection pattern elements and the corresponding light source.

8. A liquid crystal display apparatus comprising a liquid crystal display panel for generating an image and the surface light source device according to claim 1 for illuminating the liquid crystal display panel.

9. A mobile phone comprising the liquid crystal display apparatus defined in claim 8 and having a communication function.

10. An information terminal comprising the liquid crystal display apparatus defined in claim 8 and having an information processing function.

11. A liquid crystal display apparatus comprising a liquid crystal display panel for generating an image and the surface light source device according to claim 5 for illuminating the liquid crystal display panel.
